(19) United States
(12) Patent Application Publication
(10) Pub. No.: US 2019/0325509 A1
(43) Pub. Date: Oct. 24, 2019

(54) SYSTEMS AND METHODS FOR GENERATING VIRTUAL ITEMS

(71) Applicant: Walmart Apollo, LLC, Bentonville, AR (US)

(72) Inventors: Anup Nair, Ashburn, VA (US); Anushree Rao, Herndon, VA (US); Roshan Gurumurthy, Vienna, VA (US); Serdar Kurbanov, Reston, VA (US); Tarun Verma, Herndon, VA (US)

(21) Appl. No.: 16/389,079

(22) Filed: Apr. 19, 2019

Related U.S. Application Data
(60) Provisional application No. 62/660,526, filed on Apr. 20, 2018.

(51) Int. Cl. G06Q 30/06; G06F 16/21; G06F 16/29; H04W 4/029; H04W 4/33

(52) U.S. Cl. CPC G06Q 30/0643; G06F 16/219; H04W 4/33; G06Q 30/0639; H04W 4/029; G06F 16/29

(57) ABSTRACT

A system for generating virtual items is described that includes an augmented reality (AR) item generator engine configured to determine and assign a location in a facility for virtual items based on a transaction history of a user of a mobile application, historical facility data, and a first set of rules using machine learning to increase visits to selected locations in the facility. The AR item generator engine also transmits instructions to the mobile application to present the virtual items on a map of the facility. Each virtual item is viewable in the mobile application via augmented reality at an assigned location in the physical facility. The AR item generator engine also monitors a route of the mobile computing device within the facility based on a transmitted location from the mobile device, and receives a notification from the application when the user has collected a virtual item.

### CROSS-REFERENCE TO RELATED PATENT APPLICATIONS

This application claims priority to U.S. Provisional Application No. 62/660,526, filed on Apr. 20, 2018, the content of which is hereby incorporated by reference in its entirety.

### BACKGROUND

Modern computing and display technologies have facilitated the development of systems for both “virtual reality” or “augmented reality” experiences, wherein digitally reproduced images or portions thereof are presented to a user in a manner wherein they seem to be, or may be perceived to be, real.

### BRIEF DESCRIPTION OF DRAWINGS

To assist those of skill in the art in making and using a system for generating virtual items and associated methods, reference is made to the accompanying figures. The accompanying figures, which are incorporated in and constitute a part of this specification, illustrate one or more embodiments of the present invention and, together with the description, help to explain the present disclosure. Illustrative embodiments are shown by way of example in the accompanying drawings and should not be considered as limiting. In the figures:

FIG. 1 illustrates an exemplary network for a virtual items generation system, in accordance with an exemplary embodiment;

FIG. 2 illustrates a sample map of a facility, according to an exemplary embodiment;

FIG. 3 illustrates an application displaying locations for virtual items shown on the sample map of the facility shown in FIG. 2;

FIG. 4 illustrates an instruction message shown on the application when an user reaches a location of a virtual item, according to an exemplary embodiment;

FIG. 5 illustrates a rewards message shown on the application after the user performs an action to collect the virtual item, according to an exemplary embodiment;

FIG. 6 illustrates a virtual item shown in augmented reality using the application, according to an exemplary embodiment;

FIG. 7 is a method for generating virtual items, according to an exemplary embodiment; and

FIG. 8 is a block diagram of an example computing device that can be used to perform one or more steps provided by exemplary embodiments.

### DETAILED DESCRIPTION

Advanced technologies, such as smartphones, enable interactions with customers within a retail facility to provide the customers with services and information. Such interactions are beneficial for both customers and the retail facility as the customers can receive valuable information and an enhanced shopping experience and the retail facility can receive valuable customer feedback and establish stronger connections with the customers. In particular, gamification (e.g., an application of game elements and digital game design techniques to non-game problems, such as business challenges) has a potential as a source of entertainment as well as elevating the shopping experience for the customers.

Systems and methods are provided herein for generating virtual items in accordance with exemplary embodiments. In one embodiment, the system includes a database storing transaction history for an individual and an application on a mobile computing device operated by the individual (also referred to herein as the “mobile application”). The application displays a map of a facility to the individual using the mobile computing device (hereafter referred to as “user”), transmits a location of the mobile computing device within the facility to a remote server or other computing device, and displays virtual items in augmented reality. In an exemplary embodiment, a virtual item is a virtual character, a virtual object, or a virtual coin. The system further includes an augmented reality (AR) item generator engine executed by the remote server or other computing device that is communicatively coupled to the database and the application. The AR item generator engine obtains location data from the mobile computing device. The AR item generator engine further obtains transaction history of the user from the database. The AR item generator engine determines and assigns a location in the facility for each of multiple virtual items based on the transaction history of the user, historical facility data, and a first set of rules using machine learning to increase visits to selected locations in the facility. The first set of rules identifies at least one location within the facility that the user has visited more or less than a first threshold number of visits and at least one location within the facility exceeding or failing to exceed a second threshold number of generated transactions occurring at that location.

In one embodiment, the AR item generator engine instructs the application to present the virtual items on the map. Each virtual item is viewable in the application via augmented reality at an assigned location in the physical facility. The AR item generator engine also monitors a route of the mobile computing device within the facility based on the transmitted location and receives a notification from the application that the user has collected a first virtual item of a group of virtual items.

In some embodiments, the AR item generator engine dynamically determines and assigns a location in the facility for at least one additional virtual item based at least in part on the route. The AR item generator engine transmits the location of the at least one additional virtual item to the application executing on the mobile computing device for display.

In some embodiments, the system further includes a reward engine coupled to the AR item generator engine. The reward engine determines a value for each virtual item based on a second set of rules. For example, in one exemplary embodiment, the second set of rules includes at least one of the transaction history of the user, sales within one or more departments within the facility, promotions within the facility, a number of customers in a location in the facility, transaction history per customer per aisle per facility, and sales history per product per aisle per facility. The reward engine also receives a notification that the user has collected a virtual item of a predefined value and applies the predefined value to an account of the user stored in an account database.

In some embodiments, the mobile application obtains a theme for the map based on a selection or a preference by the user, such as, but not limited to, an adventure island map, a spaceship map, or a pirate ship map. The mobile application may display the map to the user using the theme.

In some embodiments, the mobile application identifies that a required action is performed by the user using the mobile computing device at the location of the first virtual item. Based on the identification of the performance of the action, the mobile application transmits the input to the AR item generator engine that the user has collected the first virtual item of the group of virtual items pursuant to the action. Exemplary actions are described further below.

In some embodiments, the AR item generator engine receives from the user an indication of a proposed location within the facility for a user-provided virtual item. The AR item generator engine transmits the location of the user-provided virtual item to a second application executing on a second mobile computing device of a second user within the facility. The AR item generator engine subsequently may receive a notification from the second application that the second user has collected the user-provided virtual item and applies a predefined value to an account of both the first user and the second user that are respectively stored in an account database.

The systems and methods described herein provide a personalized user experience and stimulate buying activity by directing users/customers to targeted locations within a facility. Embodiments described herein enhance interaction between the users and the retail facility by providing an in-store game. The in-store game provides users with a customized facility map with some collectible virtual items placed in locations within the facility. The in-store game further provides a personalized and fun experience for the users, and provides rewards for gaming activity to create a stronger incentive to play the game. The systems and methods may further provide additional exposure to products which a user has bought less/never/infrequently based on the user's transaction history, or may provide user exposure to products that have low sales velocity based on sales data of the products in the facility in general.

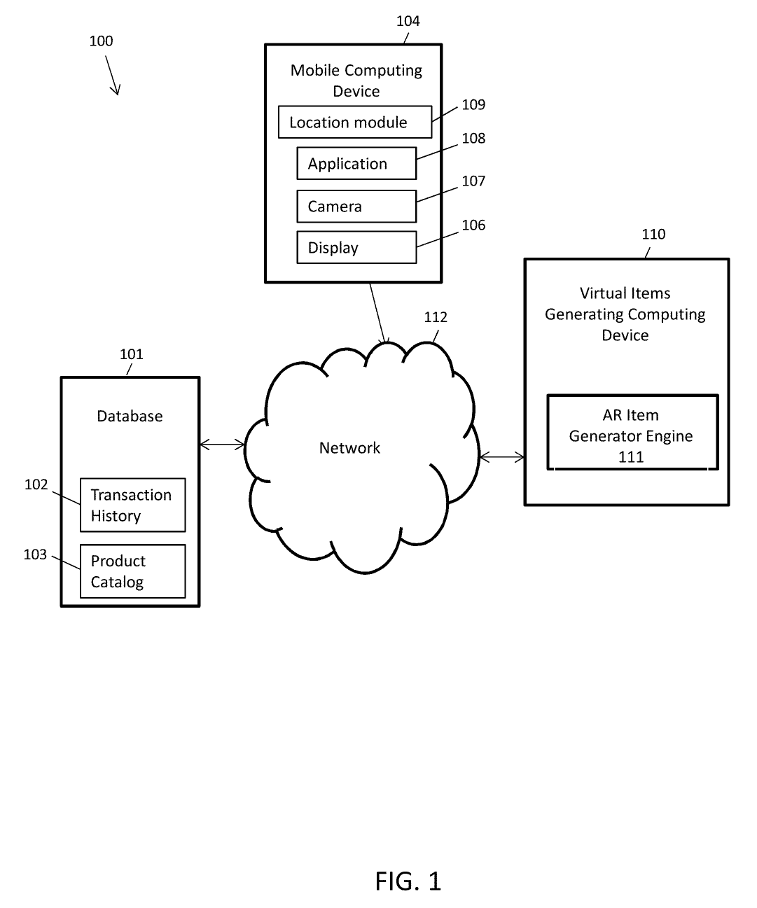

FIG. 1 illustrates an exemplary network for a virtual items generation system 100 for a facility, in accordance with an exemplary embodiment. The system 100 includes at least one database 101 storing transaction history 102 for a user of a mobile application. The transaction history 102 includes transactions made by the individual within physical facilities and/or transactions made online, where the transactions are associated with the user (for example, using an account or e-wallet associated with the user, using a credit card associated with the user, etc.). In some embodiments, the database 101 further stores a product catalog 103 containing information on product locations within the facility.

The system 100 further includes at least one mobile computing device 104 with a display 106, a camera 107, and executing an application 108 that displays a map of the facility, transmits a location of the mobile computing device 104 within the facility, and displays virtual items in augmented reality using the mobile computing device 104. The application 108 may be available as a standalone smartphone application or as a part of an application for a larger ecosystem (for example, within a shopping application for a store). The mobile computing device 104 may be, for example, a smartphone, a tablet or some other type of electronic device equipped with a display 106, a camera 107 and location module 109. As a non-limiting example, location module 109 may support the use of on-board GPS capability, Wi-Fi communication or some other location-based technique enabling the mobile device to ascertain its location.

The system 100 further includes at least one virtual items generation computing device 110 equipped with a processor configured to execute an augmented reality (AR) item generator engine 111. It will be appreciated that the AR item generator engine 111 may be provided as a series of executable software and/or firmware instructions. Although the database 101 is shown as remote from the computing device virtual items generation computing device 110, in alternative embodiments, the at least one database 101 can exist within the virtual items generation computing device computing device 110.

The virtual items generation computing device 110 communicates, via a communications network 112, with the mobile computing device 104 located within the facility. The location module 109 is used by the application 108 for tracking a location of the mobile computing device 104 within the facility. In some embodiments, the facility includes a Wi-Fi positioning system for finding a position of the mobile computing device 104 within the facility using Wi-Fi and communicating the position to the application 108.

The communications network 112 can be any network over which information can be transmitted between devices communicatively coupled to the network. For example, the communication network 112 can be the Internet, an Intranet, virtual private network (VPN), wide area network (WAN), local area network (LAN), and the like.

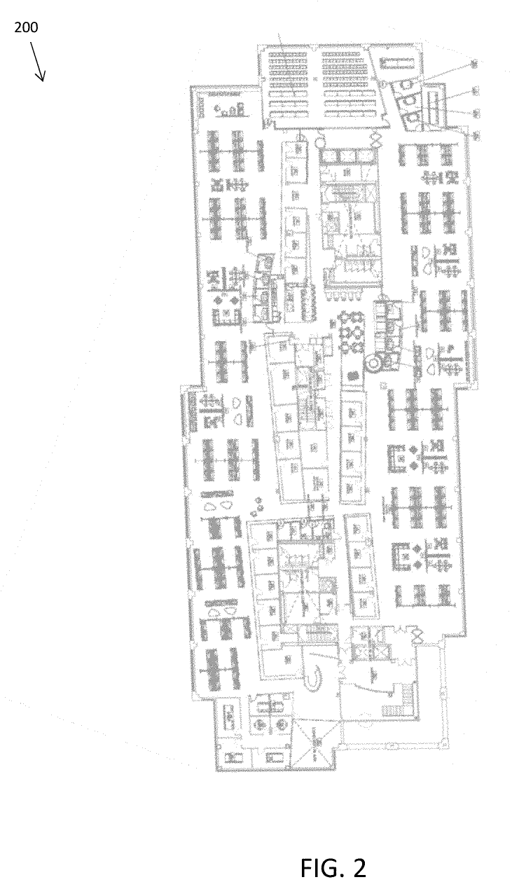

FIG. 2 illustrates a sample map 200 of a facility, according to an exemplary embodiment. The map 200 of the facility displays different departments and aisles within the facility, and enables the user to navigate through the facility. In some embodiments, the map 200 is rendered in the application 108 according to a theme. The theme may improve the attractiveness of the game by adjusting the gaming environment according to an interest or preference of the user.

The theme may be based on available information about user preferences of the user. In one embodiment, a database may store a theme preference selected by the user. In such an embodiment, the displayed virtual items may match the theme. For example, where the theme is an adventure island map, the virtual items may be displayed on map 200 as treasure chests. Similarly, the virtual items may be displayed in augmented reality via the application 108 as treasure chests.

In an alternative embodiment, using data associated with purchase activity of the user, the application 108 can select among different customizations of the map 200 that match the preferences of the user. For example, based on products that the user has bought in the past, the application 108 can categorize the interests of the user. For example, the user may prefer watching science fiction content, adventure content, or magic content. Knowing the preferred category, the application 108 provides a customization of map 200 to the user, decorated in ‘sci-fi’ style (galaxy map), ‘adventure’ style (pirate map) or ‘magic’ style (castle map). The virtual items on the map 200 (and the interaction they require to be collected) match the selected map style (for example, blaster in the first case, treasure in the second case, and a wand in the third case).

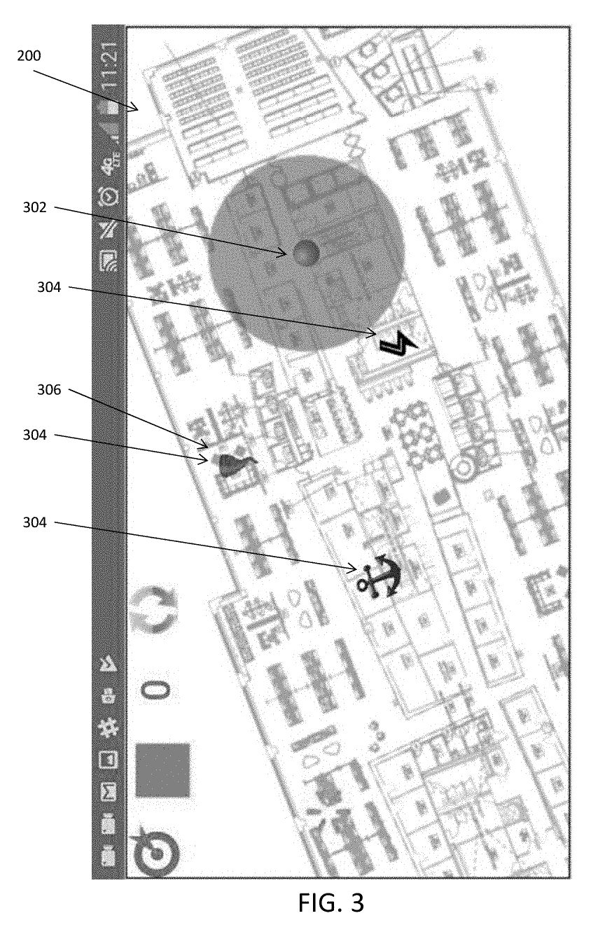

FIG. 3 illustrates the application 108 displaying locations of virtual items on the map 200 of the facility shown in FIG. 2, according to an exemplary embodiment. The application 108 may be started when a user is located within the facility. The application 108 can be started by direct action by the user or automatically when the user enters the facility. The user is able to zoom in and out of the map 200 of the facility using the application 108. In some embodiments, the map 200 can be customized according to a theme.

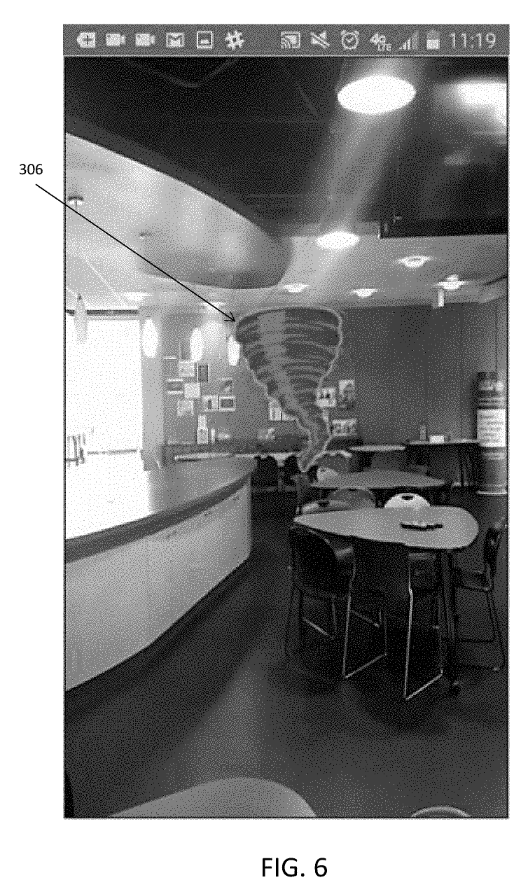

The map 200 contains a predefined number of collectible virtual items 304 placed in different locations. In an exemplary embodiment, the AR item generator engine 111 determines and assigns a location in the facility, displayable on the map 200, for each virtual item 304 based on at least one of a transaction history of the user, historical facility data, and a first set of rules, using machine learning to increase visits to selected locations in the facility. The first set of rules includes identifying at least one location within the facility that the user has visited more or less than a first threshold number of visits and at least one location within the facility exceeding or failing to exceed a second threshold number of generated transactions occurring at that location. The AR item generator engine 111 transmits instructions to the application 108 to present the virtual items 304 on the map 200. Each virtual item 304 is viewable in the application 108 via augmented reality at a location of the virtual item 304, as shown in FIG. 6.

The transaction history of the user may include past purchases of products made by the user. For example, in one embodiment, a virtual item 304 may be located near one or more products that the user has a history of buying or products similar to past purchases. Conversely, in other embodiments, the virtual item 304 may be located near one or more products that the user has never bought or has bought infrequently in an effort to draw such products to the user's attention.

The historical facility data may include sales within one or more departments within the facility, promotions within the facility, a number of customers in a location in the facility, sales history per product per aisle per facility, per customer per aisle per store, the sales history per product/aisle per store, including, but not limited to, a product/brand that requires a raise in sales. For example, where there is low sales velocity for a product located in a location of the facility, placing a virtual item 304 near the product provides a promotion of the product (either only for that single store or for multiple stores). For example, the virtual item 304 may draw an attention of the user to the product, thereby exposing the user to the product and creating awareness by the user of the product. In one embodiment, each virtual item 304 is associated with a physical coordinate within the facility.

In one embodiment, the initial placement of virtual items 304 at the start of the game in the facility is based on the output of machine learning models which utilizes data regarding locations within the facility that the user has visited more or less than a first threshold number of visits and/or locations within the facility exceeding or failing to exceed a second threshold number of generated transactions occurring at the location. The machine learning models are used to decide in which aisles/departments in the facility the virtual items 304 are placed for a future visit to the facility by the user. In some embodiments, the machine learning models are trained on data derived from the transaction history of the user. For each product purchase in a transaction, the AR item generator engine 111 receives information about the product purchase, such as departments visited offering the product, a quantity of the product bought, a total price, and a unit price of the product. Each of these transactions may be categorized into two categories—“place a virtual item” and “do not place a virtual item” based on whether the transaction information merits the placement of virtual items 304 in different departments of the facility. The categorization for training can be done on a number of factors based on the end goal. For example, if the aim is to drive the user to buy more from those aisles in the store where their average spending is more (perhaps because the user like those products), then the AR item generator engine 111 marks those departments with a high average spending as “place a virtual item”. On the contrary, to drive the user to those aisles where an average spending by the user is less (perhaps because they are not exposed to the products in those aisles), the AR item generator engine 111 marks those aisles as “place the virtual item”. These are non-limiting examples and more complex set of conditions can be set to determine how to place the virtual items 304. As the user makes multiple visits to the facility, the AR item generator engine 111 receives more data that can used to train the machine learning models. Once the machine-learning model is trained, the transaction data from each visit to the facility can be used to determine into which aisles to place the virtual items 304 on the user's subsequent visits to the facility.

The AR item generator engine 111 may also utilize live data received from the application 108 on the mobile computing device 104 of the user as the user plays the game in the facility. In one embodiment, the AR item generator engine 111 receives information regarding how the user moves around different aisles in the facility (based on, for example, Wi-Fi tracking), an amount of time spent in an aisle or aisles, a heat map of the movement of different customers between the aisles, etc. In such an embodiment, the AR item generator engine 111 uses this live data captured through the application 108 to place virtual items 304 in real-time while the user is shopping in the facility. For example, if the user spends considerable time in an aisle, the AR item generator engine 111 can create a virtual item 304 there to incentivize or reward the user for spending time in the aisle. Alternatively, if the AR item generator engine 111 tracks the user completing a tour of the store and heading to a payment counter, the AR item generator engine 111 can create virtual items 304 in aisles where the user did not visit, so that the user is incentivized to go to those aisles. These are non-limiting examples, and other conditions can be set to decide where to place the virtual items 304 in real-time, based on user movement around the facility

In one embodiment a location of the user on the map 200 is marked with a current location marker 302. The location may be received from the mobile computing device 104 after being determined using a GPS capability of the mobile computing device 104 and/or an available in-store positioning system using Wi-Fi, or other suitable location determination technique.

In an embodiment, each virtual item 304 may have a unique appearance, such as, but not limited to, a tornado, an anchor, or a thunderbolt. An appearance of a virtual item 304 displayed on map 200 may be dependent on a predefined type for the virtual item 304. For example, a virtual item 306 may be of a tornado type, and appear on the map 200 as a tornado. As described in FIG. 6, the virtual item 306 also appears as a tornado in augmented reality.

A virtual item 304 may be collected by the user once the user has physically navigated to a location of the virtual item 304. The AR item generator engine 111 and/or the application 108 monitors a route of the mobile computing device 104 within the facility based on the transmitted location. The user receives a predefined value for collecting a virtual item 304. Each virtual item 304 may be worth a different value and may require different actions or interactions in order to be collected when the user reaches the location of the virtual item 304. For example, in one embodiment, the application 108 identifies that an action (for example, spinning in a circle following a prompt from the application) is performed by the user using the mobile computing device 104 in the location of the virtual item 304. The application 108 transmits an input to the AR item generator engine 111 that the user has collected the virtual item 304 pursuant to the action.

The AR item generator engine 111 receives a notification from the application 108 that the user has collected a virtual item 304 after the application detects performance of the required action. In some embodiments, a reward engine coupled to the AR item generator engine 111 determines a value for each virtual item based on a second set of rules. The reward engine may receive a notification from the AR item generator engine 111 that the user has collected the virtual item 304 of a predefined value and apply the predefined value to an account of the user stored in an account database. In an exemplary embodiment, the second set of rules includes at least one of the transaction history of the user, sales within one or more departments within the facility, promotions within the facility, a number of customers in a location in the facility, transaction history per customer per aisle per facility, and sales history per product per aisle per facility.

In some embodiments, the user is able to provide feedback on a product that the user has bought in past. This feature will help the user collect more rewards. When the user walks into an aisle to collect a virtual item 304, an icon may appear on the application 108. If the user clicks on the icon, a notification is displayed via the application 108 that asks the user to provide feedback on a product that the user has bought in the past and is present in that aisle. In one embodiment, the feedback will be in the form of star ratings. This feature helps in keeping the user interested in the game by providing power ups during the game and therefore, a reason for the user to give feedback on a regular basis. The AR item generator engine 111 may receive the ratings about the product. The ratings may be posted online. In some embodiments, the ratings will be monitored and only the ratings that are legitimate will be posted. For example, if the user gives 5 star for all rated products, including products that have bad ratings from others, the appearance of this feature may reduce and/or the user may be asked to provide true feedback.

In another embodiment, the user is able to virtually place virtual items 304 around the facility using the application 108 for other users to collect the placed virtual items 304. If a virtual item 304 placed by the user is picked up by another user, both users receive rewards. The amount of rewards collected depends on a location (e.g., department, shelf, etc.) where the virtual item 304 was placed and a heat map of customer activity in the facility. The relation is inversely proportional; the less the activity in the location, the more is the amount of rewards earned from that location. This feature incentivizes the user to play the game in the facility, and to interact with the other users in the game.

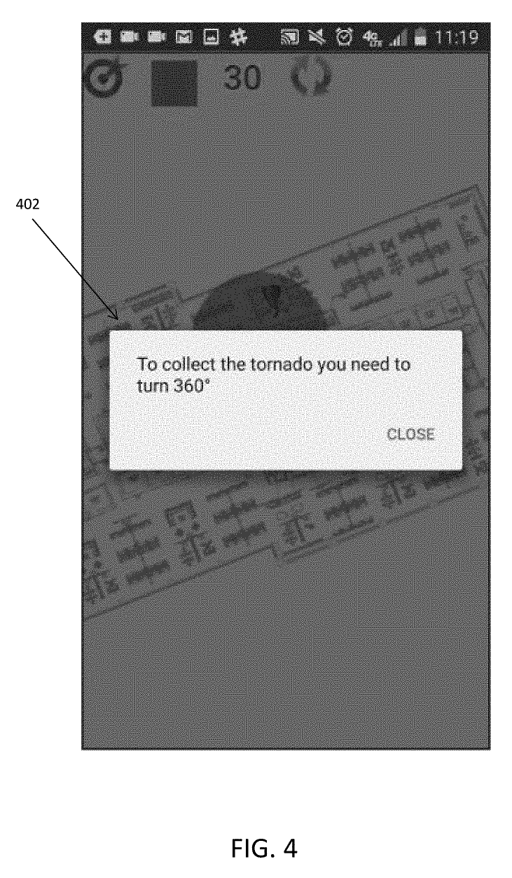

FIG. 4 illustrates an instruction message 402 displayed on the application 108 when the user reaches a location of virtual item 306, according to an exemplary embodiment. Once the user is within the approximate location of the virtual item 306 as displayed on the map 200, instruction for an action required to collect the virtual item 306 is displayed (or popped up) on the application 108. The application 108 instructs the user on an action needed to collect the virtual item 306, for example, to perform a certain physical movement. The action may be based on preferences of the user. The preferences may be estimated using the user's transaction history, online activity, and other data that system possesses about the user. For example, as illustrated, the user may be instructed to turn 360 degrees to the collect the virtual tornado item 306. Different virtual items 304 may be associated with different actions. In one embodiment, the action is dependent on a type for the virtual item 304. For example, a virtual item 304 of a treasure chest type may require the user to perform a physical action similar to opening a chest.

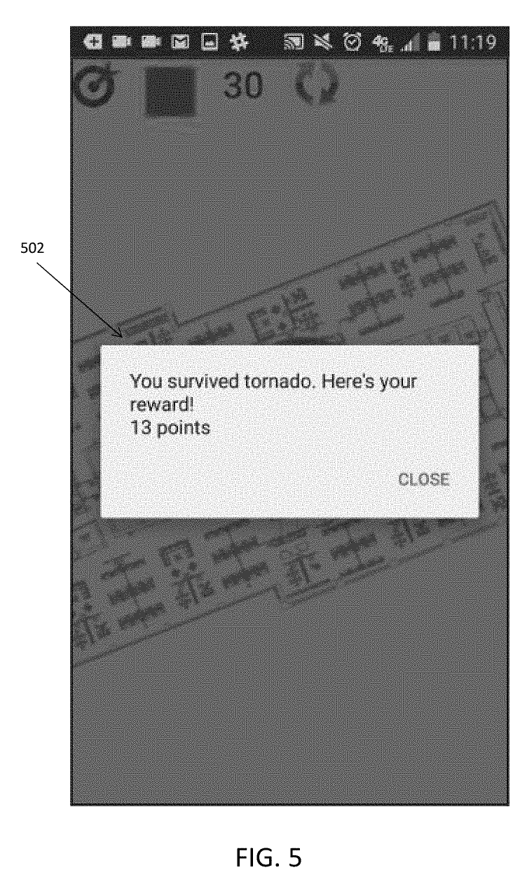

FIG. 5 illustrates a rewards message 502 shown on the application 108 after the user performs the action to collect the virtual item 306, according to an exemplary embodiment. A reward is given to the user for performing an action associated with the virtual item 306. The reward may be based on preferences of the user or based on the user's transaction history, in-store and/or online activity, and/or other data that the system possesses about the user. The rewards may be, for example, adding value to an e-wallet and/or discounts on products or purchases. For example, if the user prefers shopping in-store, the rewards may be associated with receiving a discount on particular products in store. Conversely, if the user prefers shopping online, the rewards may be associated with receiving a discount on particular products found online. In some embodiments, machine learning algorithms are used to provide suggestions on rewards based on the user's transaction history, in-store and/or online activity, and/or other data that systems possesses about the user.

FIG. 6 illustrates a virtual item 306 shown in augmented reality via application 108, according to an exemplary embodiment. At the approximate location of the virtual item 306 as displayed on the map 200, the application 108 uses the camera 107 to obtain real world images and then uses augmented reality to overlay an AR depiction of the virtual item 306 over the real world images. An appearance of the virtual item 306 shown via augmented reality is dependent on a predefined type for the virtual item 306. For example, the illustrated virtual item 306 is of a tornado type, and appears as a tornado in augmented reality.

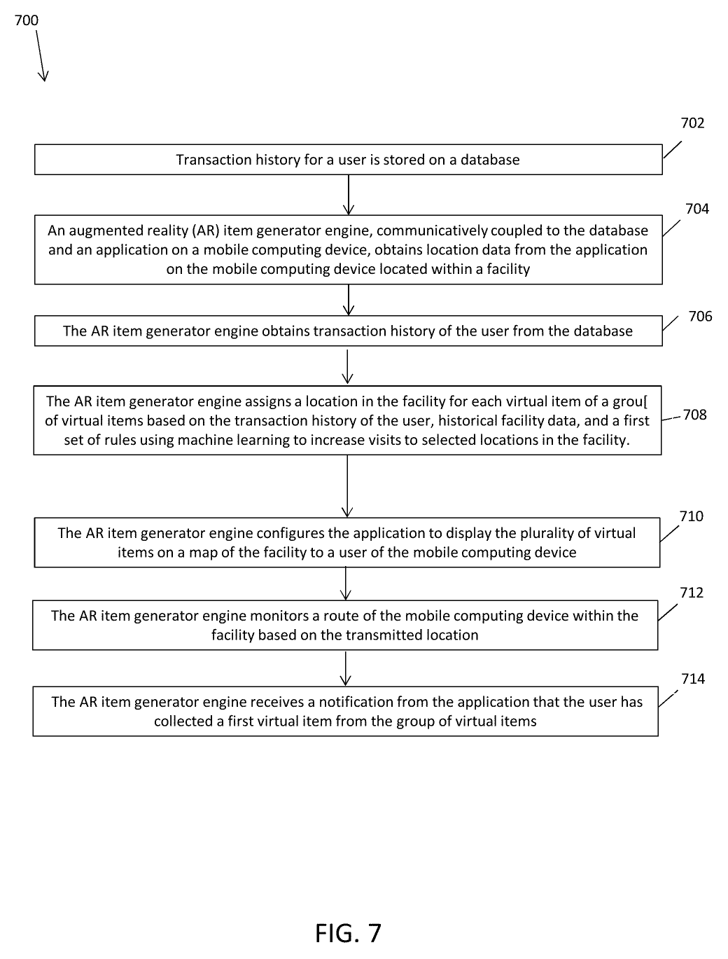

FIG. 7 is a method 700 for generating virtual items, according to an exemplary embodiment. At operation 702, transaction history for a user is stored in a database. At operation 704, an augmented reality (AR) item generator engine, communicatively coupled to the database and an application on a mobile computing device, obtains location data from the application on the mobile computing device located within a facility. At operation 706, the AR item generator engine obtains transaction history of the user from the database. At operation 708, the AR item generator engine determines and assigns a location in the facility for each virtual item of a group of virtual items based on the transaction history of the user, historical facility data, and a first set of rules using machine learning to increase visits to selected locations in the facility. The first set of rules identifies at least one location that the user has visited more or less than a first threshold number of visits and locations within the facility exceeding or failing to exceed a second threshold number of generated transactions.

At operation 710, the AR item generator engine configures the application to display the virtual items on a map of the facility to a user of the mobile computing device. Each virtual item is viewable in the application via augmented reality at an location in the physical facility.

At operation 712, the AR item generator engine monitors a route of the mobile computing device within the facility based on the transmitted location. At operation 714, the AR item generator engine receives a notification from the application that the user has collected a first virtual item of the group of virtual items and updates an account of the user.

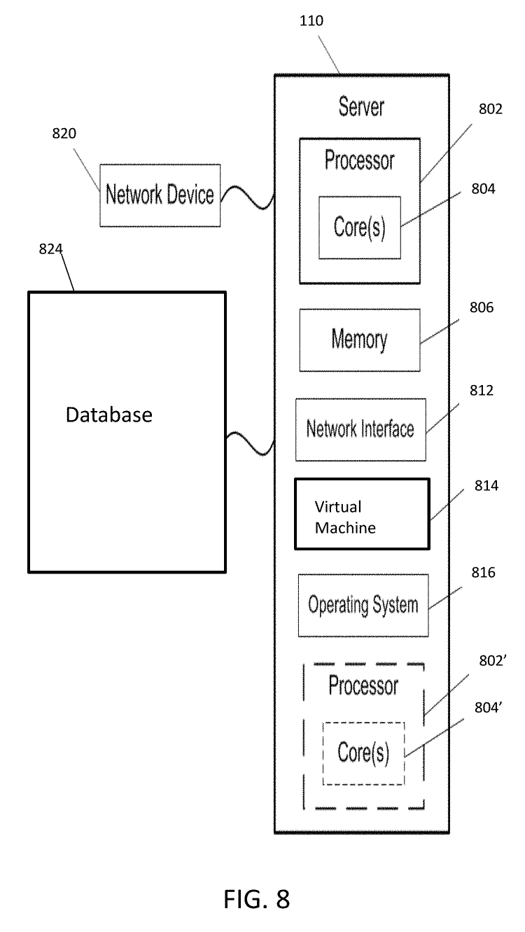

FIG. 8 is a block diagram of an example computing device 800 that can be used to perform one or more steps provided by embodiments described herein. In an exemplary embodiment, computing device 800 is a mobile computing device 104 and/or a virtual items generation computing device 110 shown in FIG. 1. Computing device 800 includes one or more non-transitory computer-readable media for storing one or more computer-executable instructions or software for implementing embodiments described herein. The non-transitory computer-readable media can include, but are not limited to, one or more types of hardware memory, non-transitory tangible media (for example, one or more magnetic storage disks, one or more optical disks, one or more USB flash drives), and the like. For example, a memory 806 included in computing device 800 can store computer-readable and computer-executable instructions or software for implementing embodiments described herein. Computing device 800 can also include a processor 802 and an associated core 804, and optionally, one or more additional processor(s) 802′ and associated core(s) 804′ (for example, in the case of computer systems having multiple processors/cores), for executing computer-readable and computer-executable instructions or software stored in memory 806 and other programs for controlling system hardware. Processor 802 and processor(s) 802′ can each be a single core processor or multiple core (804 and 804′) processor. Computing device 800 may further include an AR item generator engine.

Virtualization can be employed in computing device 800 so that infrastructure and resources in the computing device can be shared dynamically. A virtual machine 814 can be provided to handle a process running on multiple processors so that the process appears to be using only one computing resource rather than multiple computing resources. Multiple virtual machines can also be used with one processor.

Memory 806 can include a computer system memory or random access memory, such as DRAM, SRAM, EDO RAM, and the like. Memory 806 can include other types of memory as well, or combinations thereof. In some embodiments, a customer can interact with computing device 800 through a visual display device, such as a touch screen display or computer monitor, which can display one or more customer interfaces that can be provided in accordance with embodiments. The visual display device may also display other aspects, elements and/or information or data associated with embodiments. Computing device 800 may include other I/O devices for receiving input from a customer, for example, a keyboard or any suitable multi-point touch interface, such as a pointing device (e.g., a pen, stylus, mouse, or trackpad). The keyboard and pointing device may be coupled to visual display device. Computing device 800 may include other suitable conventional I/O peripherals.

For example, where computing device 800 is a mobile computing device (such as mobile computing device 104), computing device 800 may include a touch screen display, a camera, and a location module, and may execute an application that displays a map of the facility and displays virtual items in augmented reality.

Computing device 800 can also include one or more storage devices 824, such as a hard-drive, CD-ROM, or other computer-readable media, for storing data and computer-readable instructions and/or software. Exemplary storage device 824 can also store one or more storage devices for storing any suitable information required to implement embodiments.

Computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 812 can include a built-in network adapter, network interface card, PCMCIA network card, card bus network adapter, wireless network adapter, USB network adapter, modem or any other device suitable for interfacing computing device 800 to any type of network capable of communication and performing the operations described herein. Moreover, computing device 800 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 800 can run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 816 can be run in native mode or emulated mode. In an exemplary embodiment, the operating system 816 can be run on one or more cloud machine instances.

The description herein is presented to enable any person skilled in the art to create and use a computer system configuration and related method and systems for generating virtual items within a facility. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps can be replaced with a single element, component or step Likewise, a single element, component or step can be replaced with multiple elements, components or steps that serve the same purpose. Moreover, while embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system comprising:
a database storing transaction history for a user;
an application on a mobile computing device configured to:
display a map of a facility to the user of the mobile computing device,
transmit a location of the mobile computing device within the facility, and
display virtual items in augmented reality; and
an augmented reality (AR) item generator engine communicatively coupled to the database and the application, the AR item generator engine configured to:
obtain location data from the mobile computing device,
obtain transaction history of the user from the database,
determine and assign a location in the facility for each virtual item of a plurality of virtual items based on the transaction history of the user, historical facility data, and a first set of rules using machine learning to increase visits to selected locations in the facility, the first set of rules identifying at least one location within the facility that the user has visited more or less than a first threshold number of visits and at least one location within the facility exceeding or failing to exceed a second threshold number of generated transactions,
transmit instructions to the application to present the plurality of virtual items on the map, each virtual item viewable in the application via augmented reality at a location of the virtual item,
monitor a route of the mobile computing device within the facility based on the transmitted location, and
receive a notification from the application that the user has collected a first virtual item of the plurality of virtual items.

2. The system of claim 1, wherein the AR item generator engine is further configured to:
determine and assign dynamically a location in the facility for at least one additional virtual item based at least in part on the route, and
transmit the location of the at least one additional virtual item to the application executing on the mobile computing device for display.

3. The system of claim 1, further comprising a reward engine coupled to the AR item generator engine, the reward engine configured to:
determine a value for each virtual item of the plurality of virtual items based on a second set of rules,
receive a notification that the user has collected a virtual item of a predefined value; and
apply the predefined value to an account of the user stored in an account database.

4. The system of claim 3, wherein the second set of rules includes at least one of the transaction history of the user, sales within one or more departments within the facility, promotions within the facility, a number of customers in a location in the facility, transaction history per customer per aisle per facility, and sales history per product per aisle per facility.

5. The system of claim 1, wherein the application is further configured to:
obtain a theme for the map based on a selection or a preference by the user; and
display the map using the theme.

6. The system of claim 1, wherein the application is further configured to:
identify that the action is performed by the user using the mobile computing device in the location of the first virtual item; and
transmit an input to the AR item generator engine that the user has collected the first virtual item of the plurality of virtual items pursuant to the action.

7. The system of claim 1, wherein the virtual item is a virtual character, a virtual object, or a virtual coin.

8. The system of claim 1, wherein the first set of rules includes at least one of the transaction history of the user, sales within one or more departments within the facility, promotions within the facility, a number of customers in a location in the facility, transaction history per customer per aisle per facility, and sales history per product per aisle per facility.

9. The system of claim 1, wherein the AR item generator engine is further configured to:
receive from the user an indication of a location within the facility for a user-provided virtual item,
transmit the location of the user-provided virtual item to a second application executing on a second mobile computing device of a second user within the facility,
receive a notification from the second application that the second user has collected the user-provided virtual item, and
apply a predefined value to an account of both the first user and the second user that are respectively stored in an account database.

10. A method for generating virtual items, the method comprising:
storing, in a database, transaction history for a user;
obtaining, via an augmented reality (AR) item generator engine communicatively coupled to the database and an application on a mobile computing device, location data from the application on the mobile computing device located within a facility;
obtaining, via the AR item generator engine, transaction history of the user from the database;
determining and assigning, via the AR item generator engine, a location in the facility for each virtual item of a plurality of virtual items based on the transaction history of the user, historical facility data, and a first set of rules using machine learning to increase visits to selected locations in the facility, the first set of rules identifying at least one locations that the user has visited more or less than a first threshold number of visits and locations within the facility exceeding or failing to exceed a second threshold number of generated transactions;
transmitting, from the AR item generator engine, instructions to the application to display the plurality of virtual items on a map of the facility to a user of the mobile computing device, wherein each virtual item is viewable in the application via augmented reality at a location of the virtual item;
monitoring, via the AR item generator engine, a route of the mobile computing device within the facility based on the transmitted location; and
receiving, via the AR item generator engine, a notification from the application that the user has collected a first virtual item of the plurality of virtual items.

11. The method of claim 10, wherein the AR item generator engine is further configured to:
determine and assign dynamically a location in the facility for at least one additional virtual item based at least in part on the route, and
transmit the location of the at least one additional virtual item to the application executing on the mobile computing device for display.

12. The method of claim 10, further comprising:
determining, via a reward engine coupled to the AR item generator engine, a value for each virtual item of the plurality of virtual items based on a second set of rules;
receiving, via the reward engine, a notification that the user has collected a virtual item of a predefined value; and
applying, via the reward engine, the predefined value to an account of the user stored in a database.

13. The method of claim 12, wherein the second set of rules includes at least one of the transaction history of the user, sales within one or more departments within the facility, promotions within the facility, a number of customers in a location in the facility, transaction history per customer per aisle per facility, and sales history per product per aisle per facility.

14. The method of claim 10, further comprising:
obtaining, via the application, a theme for the map based on a selection or a preference by the user; and
displaying, via the application, the map using the theme.

15. The method of claim 10, further comprising:
identifying, via the application, that the action is performed by the user using the mobile computing device in the location of the first virtual item; and
transmitting, via the application, an input to the AR item generator engine that the user has collected the first virtual item of the plurality of virtual items pursuant to the action.

16. The method of claim 10, wherein the virtual item is a virtual character, a virtual object, or a virtual coin.

17. The method of claim 10, wherein the first set of rules includes at least one of the transaction history of the user, sales within one or more departments within the facility, promotions within the facility, a number of customers in a location in the facility, transaction history per customer per aisle per facility, and sales history per product per aisle per facility.

18. The method of claim 10, wherein the AR item generator engine is further configured to:
receive from the user an indication of a location within the facility for a user-provided virtual item,
transmit the location of the user-provided virtual item to a second application executing on a second mobile computing device of a second user within the facility,
receive a notification from the second application that the second user has collected the user-provided virtual item, and
apply a predefined value to an account of both the first user and the second user that are respectively stored in an account database.

19. A non-transitory computer-readable medium storing instructions for generating virtual items, the instructions when executed causing:
an augmented reality (AR) item generator engine to:
1 obtain location data from an application on a mobile computing device located within a facility;
obtain transaction history of the user from a database storing transaction history for a user;
determine and assign a location in the facility for each virtual item of a plurality of virtual items based on the transaction history of the user, historical facility data, and a first set of rules using machine learning to increase visits to selected locations in the facility, the first set of rules identifying at least one location that the user has visited more or less than a first threshold number of visits and locations within the facility exceeding or failing to exceed a second threshold number of generated transactions;
transmit instructions to the application to display the plurality of virtual items on a map of the facility, wherein each virtual item is viewable in the application via augmented reality at a location of the virtual item;
monitor a route of the mobile computing device within the facility based on the transmitted location; and
receive a notification from the application that the user has collected a first virtual item of the plurality of virtual items;
wherein the first set of rules identifies at least one of locations that the user has visited more or less than a first threshold number of visits and locations within the facility exceeding or failing to exceed a second threshold number of generated transactions.

20. A non-transitory computer readable medium of claim 19, further comprising:
determining, via a reward engine coupled to the AR item generator engine, a value for each virtual item of the plurality of virtual items based on a second set of rules;
receiving, via the reward engine, a notification that the user has collected a virtual item of a predefined value; and
applying, via the reward engine, the predefined value to an account of the user stored in a database.
